(19) United States
(12) Patent Application Publication
(10) Pub. No.: US 2010/0174865 A1
(43) Pub. Date: Jul. 8, 2010

(54) DYNAMIC DATA SECURITY ERASURE

(75) Inventor: Michael J. Koester, Hollister, CA (US)

Correspondence Address: OPPENHEIMER, WOLFF & DONNELLY, LLP, PLAZA VII, SUITE 3300, 45 SOUTH SEVENTH STREET, MINNEAPOLIS, MN, 55402-1609, US

(73) Assignee: International Business Machines Corporation, Armonk, NY (US)

(21) Appl. No.: 12/349,300

(22) Filed: Jan. 6, 2009

(51) Int. Cl. G06F 12/02; G06F 12/00; G06F 12/14

(52) U.S. Cl. 711/114; 711/163; 711/166; 711/170; 711/E12.001; 711/E12.002; 711/E12.091

(57) ABSTRACT

One aspect of the present invention includes an operation to efficiently erase data from a storage device with the use of a multiple-write secure erasure technique. One embodiment includes a hardware command that sends an I/O operation to the control unit to erase a set of selected tracks (“dirty tracks”) from a storage device, and replace the set of dirty tracks within the storage device with unallocated but available tracks retrieved from an available storage pool. After allocating the previously unallocated tracks to the available storage in the storage device, the operation performs the secure erasure of the dirty tracks in the background with a secure erasure algorithm. Once the secure erasure algorithm has fully erased the dirty tracks, the tracks are then added back to the available storage pool for subsequent use within the storage system.

### FIELD OF THE INVENTION

The present invention generally relates to storage environments accessed by computing systems. The present invention more specifically relates to an efficient operation used for erasing data from storage volumes within a storage environment.

### BACKGROUND OF THE INVENTION

In a storage environment where data is stored on a volume, there are times when a complete erasure of the data may be desired. Within existing storage disks, because the data is stored on the volume in tracks, to erase these tracks, an I/O operation must be performed to each track of the device to overwrite the existing data. As a further complication to the erasure process, due to the nature of magnetic recording, it may be possible to access previously-written data on a disk even though it may have been written over more than once. Therefore, to prevent the possibility of accessing previously-written data, current secure erasure methods write random patterns on the physical media many times in order to ensure that no previously-written data is accessible. Some of these patterns were developed with assistance from the National Computer Security Center (NCSC) and are certified by the NCSC as being National Security Agency (NSA) and Department of Defense (DOD) compliant.

Additionally, further complexities are involved when implementing secure erasure methods on storage systems which utilize caching. After storage tracks are cached to memory, the tracks must also be destaged so that they are written to the physical media. Each destage of tracks requires another I/O operation across the channel. While this I/O is being performed, the tracks are not usable until the synchronous erasure operation is finished. This causes problems because repeated I/O to each track is not only time consuming, but is also channel intensive. For example, if a user wished to erase all data on a volume within a 3390 Model 3 storage device that contains 3,339 cylinders with 15 heads per cylinder, this would result in 50,085 I/O instructions just to write over each track. In some circumstances, it may take numerous hours or even days for the data erasure operation to be completed.

Due to the large number of times that the patterns must be written onto the disk and the large number of I/O operations necessary to destage a cached disk after a pattern is written to the tracks, the performance of a complete secure erasure on a disk can become a very I/O and time intensive operation. What is needed in the art is an enhanced operation which avoids the problems of channel intensive I/O, in addition to reducing the time constraints associated with the current data erasure procedure.

### BRIEF SUMMARY OF THE INVENTION

One object of the present invention is to introduce an enhanced operation for performing a data erasure on a disk, without requiring channel intensive I/O or experiencing the time constraints associated with current data erasure procedures. In one embodiment, when the user wishes to erase data on the storage device, the user would simply issue a new command that sends an I/O to the control unit, providing the range of tracks that are to be erased. One advantage of this embodiment is that the erasure is performed within the control unit, enabling the erasure to be initiated with a single I/O operation rather than multiple I/O requests across the channels. In a further embodiment, the command may be implemented as a hardware command, and may be configured to accept an added parameter to enable a user to specify how many times the data is to be written over.

In a further embodiment, the operation responsible for performing the erasure of data within the storage system exchanges the tracks to be erased with blank tracks from an available storage pool (such as an extent pool), and moves the tracks to be erased in the background. The erasure operation can then be performed asynchronously in the background, while immediately replacing the storage provided by the tracks to be erased with a usable storage space. After the erasure process has completed writing the secure erasure patterns on the disk tracks in the background, the newly erased tracks will be placed into the extent pool and will become available for storage.

In one embodiment of the present invention, an operation for performing a dynamic data security erasure on a storage device first includes the step of selecting a set of currently allocated extents or data chunks within a storage device for erasure. The units of storage specified to be erased may be a volume control unit, a logical volume, a set of tracks, or another similar configuration of the physical media. Next, a user, such as a system administrator, executes a command to erase the data from the storage system. In a further embodiment, this command may be defined as a CCW hardware command, to enable its consistent use by numerous software applications. In still a further embodiment, a range of tracks or an entire volume can be specified to be erased within the command.

As the dynamic erasure operation is commenced, the selected extents or chunks to be erased are exchanged within the storage unit with available but unallocated extents. This involves removing the selected extents from the storage device (i.e., unallocating them from the logical volume or device) and denoting them for erasure. Meanwhile, available but unallocated extents within the extent pool are allocated to the storage device to replace the set of extents selected for erasure. The selected extents are then erased on the physical storage media with the performance of a number of background write operations, consistent with a secure erasure technique. Finally, once the extents are fully erased, the extents are replaced within the storage management system to make them available for future use.

### BRIEF DESCRIPTION OF THE DRAWINGS

FIG. 1 illustrates an example configuration of a storage management system used in accordance with one embodiment of the present invention;

FIG. 2 illustrates an example secure erasure operation being performed upon an extent pool and a set of logical volumes in accordance with one embodiment of the present invention;

FIG. 3 illustrates an example configuration of an example extent pool at various stages of operation of a secure erasure method in accordance with one embodiment of the present invention; and

FIG. 4 illustrates a flowchart illustrating steps of an operation for performing a dynamic data security erasure according to one embodiment of the present invention.

### DETAILED DESCRIPTION OF THE INVENTION

One aspect of the present invention enables a single command and single channel I/O operation to be used to perform a dynamic erasure of data. This command may be configured to perform a complete erase of data on a storage system with multiple data writes on the disk in compliance with NSA and DOD requirements, without the large overhead necessary from existing synchronous disk write and erasure operations. Another aspect of the present invention involves performing this dynamic erasure process in the background while making additional tracks available to replace the deleted tracks, by swapping tracks to be erased from the logical volume or device with available but unallocated tracks obtained from an available storage pool.

As further referred to within the present disclosure, the use of the terms “storage volume”, “device”, and “logical device” are generally interchangeable, and are used to refer to units of storage tied to the physical media where data is stored. As would be evident to one skilled in the art, the enhancement of a secure erasure operation is intended to enhance the use and accessibility of a data storage container tied to a physical media, and would not be limited to a specific type of storage container or storage system configuration.

In one embodiment of the present invention, the tracks that contain a set of data to be erased and are presently assigned to a storage volume are replaced with unused tracks from the available storage pool, further referred to as an “extent pool.” This allows the storage volume to be available without delay while the original tracks are erased as a background operation. When the original tracks containing the data have been fully erased and are designated as “clean”, the original tracks are then added back to the pool and are available to be assigned within the storage system.

Within a further embodiment of the present invention, the enhanced secure erasure operation may be initiated through the use of an instruction implemented within hardware. For example, the instruction may be a new channel command word (CCW) used to initiate the secure erasure operation on a channel-attached device within a specialized I/O channel processor or other channel subsystem components, or other. This CCW may also be configured to enable the specification of a range of tracks that are to be erased along with the number of times that the data is to be overwritten. Likewise, a secure erasure operation instruction might be configured to be used in a variety of hardware and firmware settings, including removable and non-removable solid state hardware components and integrated circuits.

As an illustrative example, by deploying the secure erasure operation within a CCW instruction in hardware, the secure erasure operation may be easily used and launched by multiple software utilities. For example, the ICKDSF disk management utility facility currently has a command, “TRKFMT”, which formats tracks and erases data. The ICKDSF utility may be modified to contain a command similar to TRKFMT which issues the new CCW and initiates the secure erasure process within the background. In a further embodiment, the user would be able to specify additional parameters relevant to the secure erasure operation, such as the number of times to overwrite the tracks.

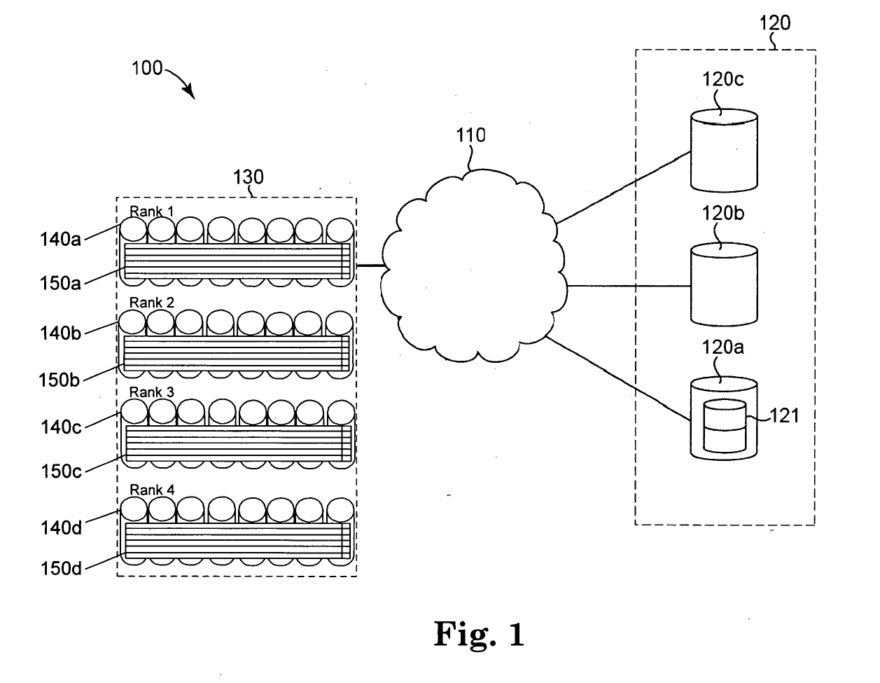

FIG. 1 depicts a configuration of an example storage management system which may be utilized to perform the disclosed dynamic secure erasure operations according to one embodiment of the present invention. As an example, the storage management system 100 depicted in FIG. 1 contains a number of logical storage volumes 120a, 120b, 120c. Each logical volume is referred to in systems such as IBM System z as a “LUN”, and each logical volume is composed of fixed block extents and exists on a storage network 110 within an allocated storage pool 120. Therefore, these LUN storage volumes serve as a logical aggregation of physical devices. Further, LUN 120a is depicted as containing a dataset 121.

As depicted, the storage management system utilizes RAID storage arrays 130 containing a set of ranks 140a, 140b, 140c, 140d which in turn contain a number of available extent tracks 150a, 150b, 150c, 150d available for storage of data. In this example, a rank is built using only one array, while the available space on each rank is divided into extents with the extent being striped across all disks of a RAID array. The extents are the building blocks of the logical storage volumes, and may be striped within the RAID array according to the RAID technique being used. The extents may be allocated as necessary to the logical storage volumes.

Thus, the RAID storage devices 130 comprise a pool of unused tracks that may be available for configuring new, or expanding existing, volumes. This pool is further referred to in the present disclosure as the “extent pool”. The extent pool further serves as a logical construct to aggregate the extents from a set of ranks to form a domain for extent allocation to a logical volume. Restated, the extent pool comprises available storage that is not currently allocated within the storage management system, but may be.

Although the configuration of FIG. 1 illustrates an extent pool 130 within a storage system containing a number of RAID devices, volumes, arrays, and tracks, one skilled in the art would recognize that the present invention is also applicable to numerous other configurations and storage settings. Specifically, the present invention is applicable to non-RAID storage systems which have an available storage pool containing unallocated data tracks or chunks which accompanies devices or volumes containing allocated data.

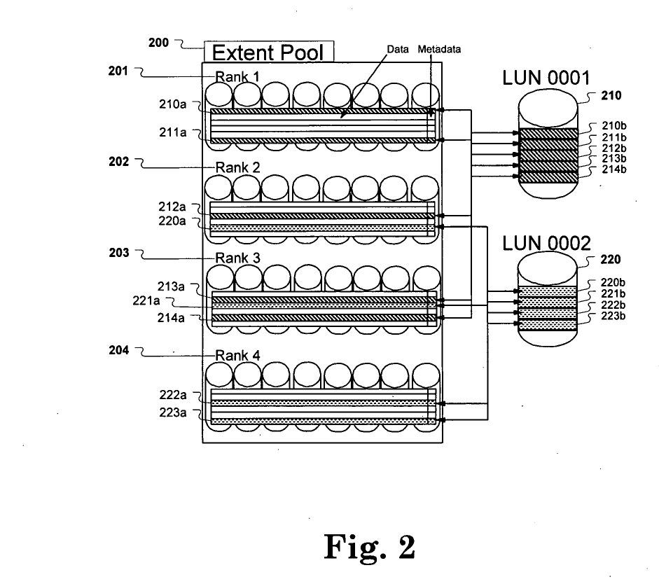

FIG. 2 depicts an example secure erasure operation being performed upon an extent pool 200 and a set of logical volumes (LUNs) 210, 220 in accordance with one embodiment of the present invention. As further shown, data for each logical volume 210, 220 exists throughout ranks 201, 202, 203, 204 (each rank representing a defined RAID array within the storage system). Although only two logical volumes are shown, one skilled in the art would recognize that a typical storage management system might involve numerous other disks and logical volumes to be configured for use with an extent pool or other available storage pool.

Within prior art systems, disk operations must wait until the erasure operation erases all tracks from the pool and fully completes. For example, to erase a set of tracks solely located within a single rank, only one I/O operation can be performed at a time during the entire amount of time that the set of tracks is being erased. In contrast, with use of this embodiment, data can be moved around within the storage volumes while the erasure occurs, because multiple erasure operations will be performed dynamically in the background.

FIG. 2 further depicts the operation of swapping allocated tracks to be erased with unallocated tracks from the extent pool, and assigning the available tracks to be allocated within the LUN. As shown, tracks 210a, 211a, 212a, 213a, 214a within the extent pool are moved to the LUN 0001 210. This set of tracks is exchanged with the “dirty” tracks 210b, 211b, 212b, 213b, 214b containing data to be securely erased. Likewise, available and unallocated tracks 220a, 221a, 222a, 223a are exchanged with dirty tracks 220b, 221b, 222b, 223b within LUN 0002 220.

Within this type of a storage system, a LUN logical volume can be created and deleted without affecting other LUNs that are assigned to tracks in the same extent pool. Taking advantage of this fact, a new command can be issued to the devices to replace the existing extents with new extents that do not contain any data. Thus, before the old extents are made available for use by another LUN within the extent pool, the old dirty extents are erased in the background.

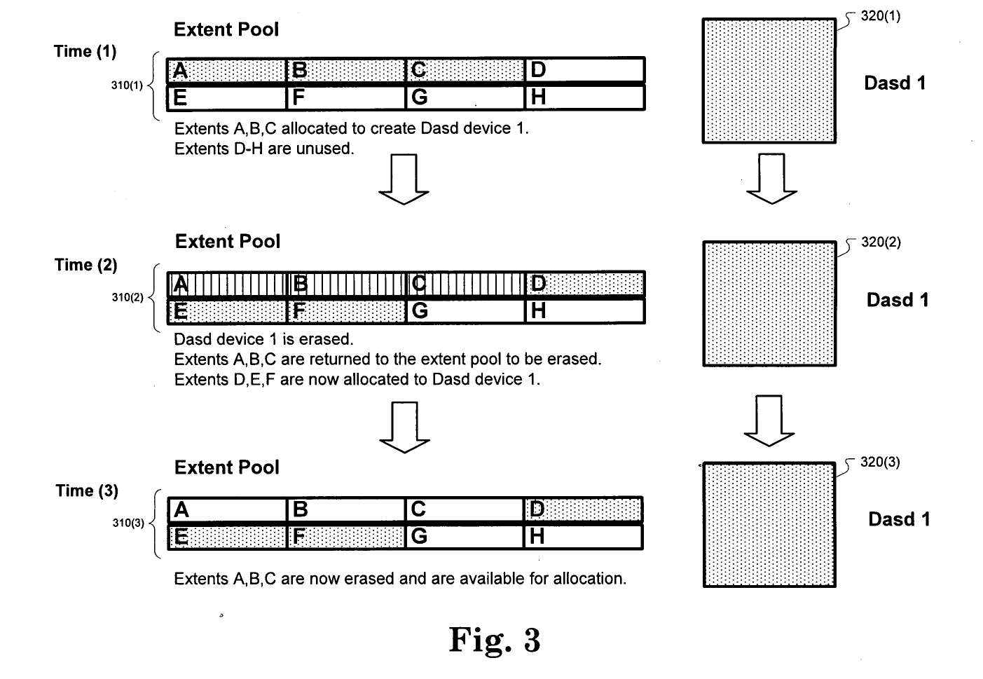

FIG. 3 depicts a configuration of an example extent pool at various stages of operation within a secure erasure method according to one embodiment of the present invention. As shown in FIG. 3, a single DASD 320 (“direct access storage device”) is depicted as the available storage within three different sequential points of time, Time (1), Time (2), Time (3). For example, this DASD may comprise a large RAID disk array.

As suggested above, the advantages of the erasure methods of the present invention are general in nature and applicable to both RAID and non-RAID storage devices and systems. Therefore, FIG. 3 is simplified to depict the use of a single device with extents (unallocated storage units) available within an available storage pool 310 (again referred to as an Extent Pool). Within this simplified storage system, when a logical volume is configured, a number of extents (i.e., available chunks of storage) are assigned to the DASD device. When the logical volume is unconfigured, these extents are returned to the Extent Pool.

Performing a secure erasure operation in accordance with this embodiment significantly reduces the amount of time it takes for a customer or other user to erase a logical volume and be able to utilize the volume. First, at Time (1), extents A,B,C within the extent pool 310(1) are allocated to create the Dasd device 1 320(1). The remainder of the extents D-H are unused. As shown between Time (1) and Time (2), a command is issued to erase the A,B,C chunks. This results in Extents A,B,C being returned to the extent pool 310(2) to be erased. Meanwhile, Extents D,E,F are allocated to the Dasd device 320(2). A simplification of the overall idea is to swap a set of “dirty extents” to be erased for “clean extents.”

By swapping in a set of clean extents into the storage device, a user can continue using the volume much sooner, without a need for the erasure operation to fully complete. Between Time (2) and Time (3), the dirty extents are scrubbed within the storage system in the background and returned to the Extent Pool for usage by other logical volumes. Thus, the extent pool 310(3) depicted in Time (3) illustrates that the previously dirty extents are now available for allocation to the Dasd device 320(3). As discussed above, by scrubbing the dirty extents in the storage system in the background, the erasure process can be initiated with a single I/O command rather than multiple I/Os across the channel.

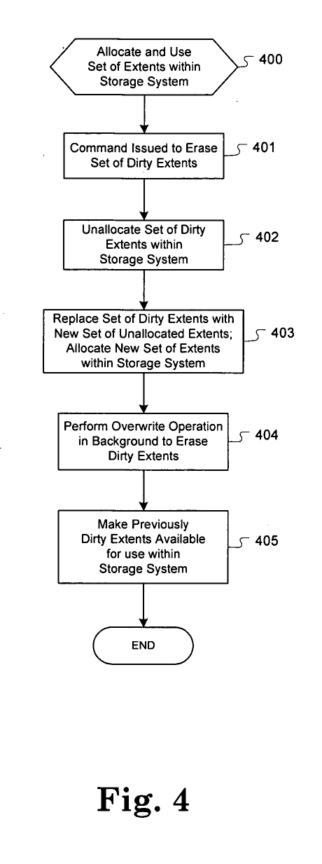

FIG. 4 depicts a flowchart of an example operation for performing a dynamic data security erasure according to one embodiment of the present invention. As discussed above, the initiation of the erasure operation itself is optimally launched with the use of one command or I/O operation. However, this flowchart shows a summarized view of the steps to manage the performance of the erasure operation, regardless of how the operation is commenced.

First, as in step 400, the operation is initiated after a set of extents are allocated and used within the storage system. Then, as in step 401, a command is issued to the storage system to erase this set of extents with use of an erasure method (or more particularly, a secure erasure method). This set of extents which contains the data to be erased is referred to as the set of dirty extents.

Next, as in step 402, the set of dirty extents is unallocated from the logical volume or other storage container within the storage system. This removes it from active use within the volume, although the data may still remain readable on the physical disk media. The storage space within the volume or storage container taken up by the dirty extents is then replaced by a new set of unallocated extents as in step 403, which exists as unallocated storage available within the extent pool or other available storage pool. This new set of extents is then allocated within the storage system, and becomes available free space for use within the volume or storage container.

Afterwards, an overwrite erasure operation is performed as an asynchronous background process to erase the set of dirty extents as in step 404, such as with use of secure erasure methods which overwrite the physical media numerous times. Once the set of dirty extents has been overwritten and fully erased with the erasure operation, then the previously dirty extents are made available for use within the storage system as in step 405. For example, the previously dirty extents may be added to exist as available storage within the extent pool or available storage pool.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A method for performing a dynamic data security erasure within a storage device, comprising:
selecting a set of extents allocated within a storage device to be erased;
exchanging the selected set of extents to be erased with an unallocated set of extents existent within an available storage pool, by allocating the unallocated set of extents to the storage device and unallocating the selected set of extents from the storage device;
erasing the selected set of extents with a plurality of background write operations upon the selected set of extents;
making the selected set of extents available within the available storage pool upon completion of the erasure process.

2. The method of claim 1, wherein the available storage pool comprises a set of RAID arrays.

3. The method of claim 2, wherein the unallocated set of extents is stored throughout the set of RAID arrays.

4. The method of claim 1, further comprising initiating the dynamic data security erasure with a hardware command upon a solid state hardware component.

5. The method of claim 1, further comprising initiating the dynamic data security erasure with one I/O hardware command.

6. A method for performing a dynamic data security erasure within a storage system, comprising:
allocating a selected set of extents from a extent pool to a logical volume, the extent pool and the logical volume contained within a storage system;
defining a hardware command to perform a dynamic data security erasure of the selected set of extents within the logical volume;
executing the hardware command within the storage system to perform the secure erasure of the selected set of extents, wherein execution of the hardware command initiates the secure erasure and replaces the set of extents within the storage system, including:
removing the selected set of extents from the logical volume;
allocating available extents from the extent pool to the logical volume to replace the selected set of extents within the logical volume;
erasing the selected set of extents using a background erasure operation performed upon the selected set of extents within the storage system.

7. The method of claim 6, wherein the hardware command issues one I/O operation within the storage management system to perform the secure erasure actions.

8. The method of claim 6, further comprising returning the selected extents to the extent pool responsive to completion of the background erasure operation.

9. A system, comprising:
at least one processor; and
at least one memory storing instructions operable with the at least one processor for performing a dynamic data security erasure within a storage device, the instructions being executed for:
selecting a set of extents allocated within a storage device to be erased;
exchanging the selected set of extents to be erased with an unallocated set of extents existent within an available storage pool, by allocating the unallocated set of extents to the storage device and unallocating the selected set of extents from the storage device;
erasing the selected set of extents with a plurality of background write operations upon the selected set of extents;
making the selected set of extents available within the available storage pool upon completion of the erasure process.

10. The system of claim 9, wherein the available storage pool comprises a set of RAID arrays.

11. The system of claim 10, wherein the unallocated set of extents is stored throughout the set of RAID arrays.

12. The system of claim 9, further comprising a solid state hardware component, wherein the instructions are executed upon the hardware component to initiate the dynamic data security erasure.

13. The system of claim 9, further comprising instructions being executed for initiating the dynamic data security erasure with one I/O hardware command.

14. A system comprising:
at least one processor; and
at least one memory storing instructions operable with the at least one processor for performing a dynamic data security erasure within a storage system, the instructions being executed for:
allocating a selected set of extents from a extent pool to a logical volume, the extent pool and the logical volume contained within a storage system;
defining a hardware command to perform a dynamic data security erasure of the selected set of extents within the logical volume;
executing the hardware command within the storage system to perform the secure erasure of the selected set of extents, wherein execution of the hardware command initiates the secure erasure and replaces the set of extents within the storage system, including:
removing the selected set of extents from the logical volume;
allocating available extents from the extent pool to the logical volume to replace the selected set of extents within the logical volume;
erasing the selected set of extents using a background erasure operation performed upon the selected set of extents within the storage system.

15. The system of claim 14, wherein the hardware command issues one I/O operation within the storage management system to perform the secure erasure actions.

16. The system of claim 14, further comprising instructions being executed for returning the selected extents to the extent pool responsive to completion of the background erasure operation.

17. A computer program product comprising a computer useable medium having a computer readable program for performing a dynamic data security erasure within a storage device, wherein the computer readable program when executed on a computer causes the computer to:
select a set of extents allocated within a storage device to be erased;
exchange the selected set of extents to be erased with an unallocated set of extents existent within an available storage pool, by allocating the unallocated set of extents to the storage device and unallocating the selected set of extents from the storage device;
erase the selected set of extents with a plurality of background write operations upon the selected set of extents;
make the selected set of extents available within the available storage pool upon completion of the erasure process.

18. The computer program product of claim 17, wherein the available storage pool comprises a set of RAID arrays.

19. The computer program product of claim 18, wherein the unallocated set of extents is stored throughout the set of RAID arrays.

20. The computer program product of claim 17, further comprising initiating the dynamic data security erasure with a hardware command upon a solid state hardware component.

21. The computer program product of claim 17, further comprising causing the computer to initiate the dynamic data security erasure with one I/O hardware command.

22. A computer program product comprising a computer useable medium having a computer readable program for performing a dynamic data security erasure within a storage system, wherein the computer readable program when executed on a computer causes the computer to:
allocate a selected set of extents from a extent pool to a logical volume, the extent pool and the logical volume contained within a storage system;
define a hardware command to perform a dynamic data security erasure of the selected set of extents within the logical volume;
execute the hardware command within the storage system to perform a secure erasure of the selected set of extents, wherein execution of the hardware command initiates the secure erasure and replaces the set of extents within the storage system, including:
removing the selected set of extents from the logical volume;
allocating available extents from the extent pool to the logical volume to replace the selected set of extents within the logical volume;
erasing the selected set of extents using a background erasure operation performed upon the selected set of extents within the extent pool.

23. The computer program product of claim 22, wherein the hardware command issues one I/O operation within the storage management system to perform the secure erasure actions.

24. The computer program product of claim 22, further comprising causing the computer to return the selected extents to the extent pool responsive to completion of the background erasure operation.
